(19) United States
(12) Patent Application Publication
(10) Pub. No.: US 2011/0132630 A1
(43) Pub. Date: Jun. 9, 2011

(54) SCREW FASTENING DEVICE AND TORQUE SENSOR

(75) Inventors: Shuji Kawamura, Tokyo (JP); Hideki Sakai, Tokyo (JP); Hideki Mayama, Tochigi (JP); Hideshi Takekuma, Tochigi (JP)

(73) Assignee: HONDA MOTOR CO., LTD., Tokyo (JP)

(21) Appl. No.: 13/058,101

(22) PCT Filed: Jul. 1, 2009
(86) PCT No.: PCT/JP2009/003046

§ 371 Date: Feb. 8, 2011

(30) Foreign Application Priority Data
Aug. 8, 2008 (JP) 2008-204946
Aug. 8, 2008 (JP) 2008-204963

(51) Int. Cl. B25B 21/00; B25B 23/147

(52) U.S. Cl. 173/178; 173/182

(57) ABSTRACT

A screw fastening device having a compact clutch that is directly connected to an output side of a DC motor. The output of the DC motor can be suppressed so that the DC motor and the clutch can be made compact. Accordingly, the device main body is more compact and lighter.

### TECHNICAL FIELD

The present invention relates to a screw fastening device using a motor as a drive source, and a torque sensor which can correctly and easily measure a fastening force of a drive side.

### BACKGROUND ART

Conventional screw fastening devices include those of an angle type, a pistol type and the like, and there is known the fastening device in which a speed reducer is connected to an output side of a motor drive section, a clutch is connected to an output side of the speed reducer, and a tool socket is provided at an output side of the clutch (for example, refer to Patent Literature 1). After a screw is fastened, a torque wrench is used to achieve required fastening torque.

As means of measuring a fastening axial force of a screw (bolt) to a fastened object, a strain gauge is interposed between the screw and the fastened object in a bridge or the like, but this is unrealistic in the manufacturing line of vehicle bodies and the like, and therefore, a torque sensor is built in a nut runner or an electric driver, so that a fastening torque value is monitored in real time, and brake is applied to stop the nut runner or the electric driver when the fastening force reaches a target fastening force.

The structures of the torque sensors include those by a magnetic strain method which detects a change of magnetic characteristics which is induced by strain, and an encoder method.

As disclosed in Patent Literature 2, in a magnetic strain method, strain gauges (usually, four) are attached to a drive shaft or an outer periphery of a member which rotates integrally with the drive shaft, these four strain gauges form a detection circuit (Wheatstone bridge circuit), and since the resistance value of the strain gauge is changed by the torsional torque which occurs to the drive shaft, the change is taken out as a voltage value to detect the torque value.

As disclosed in Patent Literature 3, an encoder method is the method which detects the angle of torsion from a phase difference of outputs of a pair of rotary encoders provided at both ends of a torsion bar.

Further, there is the mechanism which performs fastening with a constant fastening force by using a mechanical clutch without using a strain gauge. This converts the rotational force of a drive shaft into an axial force, compresses a coil spring with the axial force, and when the compression amount has a constant value, the switch is operated to stop the rotation.

### CITATION LIST

### PATENT LITERATURE

Patent Literature 1: Japanese Patent Laid-Open No. 06-079637

Patent Literature 2: Japanese Patent Laid-Open No. 11-285933

Patent Literature 3: Japanese Patent Laid-Open No. 2002-228526

### SUMMARY OF INVENTION

### Technical Problem

However, in each of the conventional screw fastening devices, a clutch is provided at the output side of the speed reducer, and therefore, there arises the problem that the clutch becomes large in capacity to be large in size due to the necessity of operating the clutch with high output torque after speed reduction, and the device becomes large in size as a whole to have low operability. Further, there also arises the problem that when the required fastening torque increases, the reaction force also increases to make an operation with one hand difficult.

The type with the strain gauges attached to the rotating shaft disclosed in Patent Literature 2 has the structure in which a rotary ring and a brush are in contact with each other, and causes the influence on the measurement precision by noise, the problem of durability due to brush abrasion, and further, an increase in the weight because non-contact coils (four) have to be used for input and output of voltage due to the structure with the strain gauges attached to the rotating shaft.

The encoder method of Patent Literature 3 detects the angle of torsion of the torsion bar, and therefore, usually makes a part of the shaft thin to make the strain large. Therefore, the device easily exceeds the stress limit, and lacks reliability.

In the case of using a mechanical clutch, there are the problems that the torque is reduced as a result of the impact force being relaxed by the spring characteristic, the positional precision of the switch has a large effect on the torque precision, further, matching of the torque and the spring constant is difficult, and the like.

The present invention is made in view of such problems which the prior arts have, and an object of the present invention is to provide a screw fastening device which adopts a compact clutch and can be made compact and light as an entire device with excellent operability and a torque sensor.

### Solution to Problem

In order to solve the above-described problems, a first invention according to claim 1 is a screw fastening device with a motor used as a drive source, wherein a clutch is connected to an output side of the motor, a speed reducer is connected to an output side of the clutch, and a tool socket is provided at an output side of the speed reducer.

The invention according to claim 2 is the screw fastening device according to claim 1, wherein electric power is intermittently supplied to the motor, and the motor is intermittently rotated.

The invention according to claim 3 is the screw fastening device according to claim 1 or 2, wherein it is determined that fastening torque reaches a desired value, in accordance with a driving time of the motor and/or an operation state of a displacement switch provided at the clutch.

The invention according to claim 4 is the screw fastening device according to claim 3, wherein the displacement switch is operated by a switch lever which senses movement of a retainer of the clutch, and a spring damper which buffers an operation of the switch lever.

In order to solve the above-described problems, a torque sensor according to a second invention includes a cam mechanism which transmits a drive force from a motor to a rotating shaft, a gauge base which is disposed around the rotating shaft without contacting the rotating shaft so as not to be rotated, and is capable of being compressed in an axial direction, a compression amount detecting element which is attached to the gauge base, and a control section which is connected to the detecting element, and turns on and off the motor in accordance with a measurement voltage corresponding to a compression amount.

As means which disposes the gauge base around the rotating shaft without contacting the rotating shaft so as not to be rotated, it is conceivable to support the gauge base floatingly at an outer side of the rotating shaft via a thrust bearing, for example.

The gauge base is formed into a cylindrical body made from a metal such as aluminum or an elastic body such as a resin. In this case, by adjusting the thickness, the compression amount in the axial direction can be controlled. More specifically, gauge bases with different thicknesses are prepared in accordance with the target detection torque values, and the gauge bases can be replaced if needed.

Further, as the cam mechanism, a structure is conceivable, which is constituted of a retainer plate which is connected to a drive shaft of the motor, a retainer which is connected to the rotating shaft, and a steel ball which connects the retainer plate and the retainer in such a manner that they are contactable with and separable from each other.

As the detecting element, a strain gauge and a piezoelectric element are suitable. In the case of a strain gauge, the detecting element is attached to an outer side of the gauge base, and in the case of a piezoelectric element, the detecting element is disposed in a space between the gauge bases divided into two in the axial direction.

### ADVANTAGEOUS EFFECTS OF INVENTION

According to the invention according to claim 1, the clutch is provided at the input side of the speed reducer instead of the output side of the speed reducer, whereby the clutch can be made compact, and therefore, the device main body which is gripped by an operator can be made compact and light. Further, as a result that the device main body gripped by the operator is compact and light, the operator can easily perform a screw fastening operation even in a narrower place.

According to the invention according to claim 2, the motor is intermittently supplied with electric power to be intermittently rotated, and thereby, torque can be increased. Further, since the motor is intermittently rotated, the reaction force is reduced, and the load on the operator can be reduced.

According to the invention according to claim 3, required fastening torque can be achieved.

According to the invention according to claim 4, the required fastening torque can be achieved with higher precision.

According to the second invention, the compression amount detecting element such as a strain gauge is attached to the gauge base which is separated from the drive shaft and is not rotated, whereby the coil for voltage input and output which has been required in the conventional torque sensor is not required, the rotary ring and the brush can be further omitted, and therefore, the number of components is decreased to be able to reduce the weight.

Since the effect of noise is eliminated, and the directly inputted voltage is read with the detecting element from the compression amount of the gauge base and is converted into torque, the measurement precision is significantly enhanced.

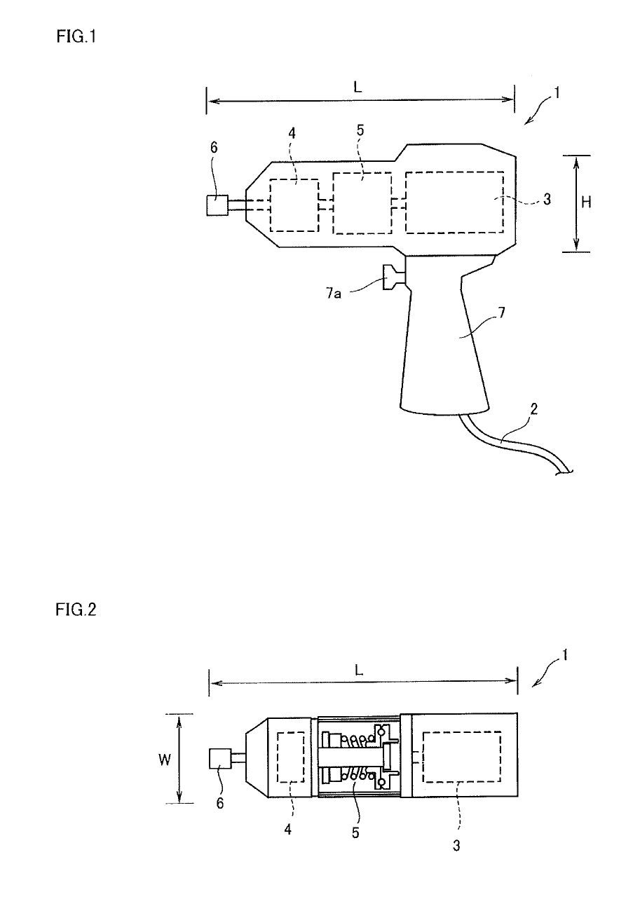

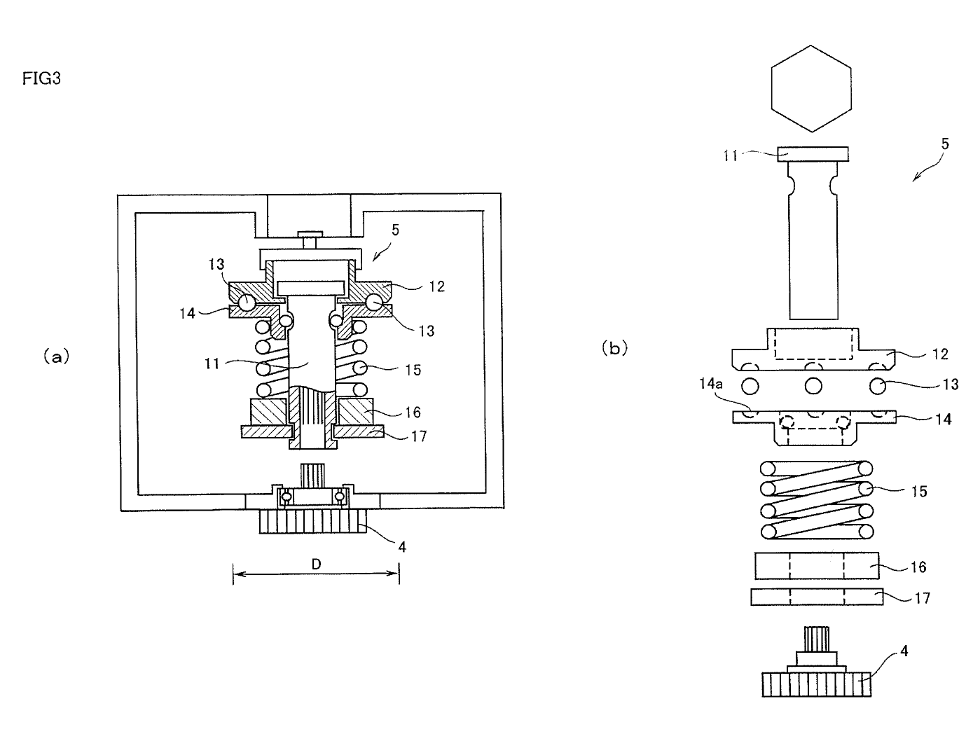

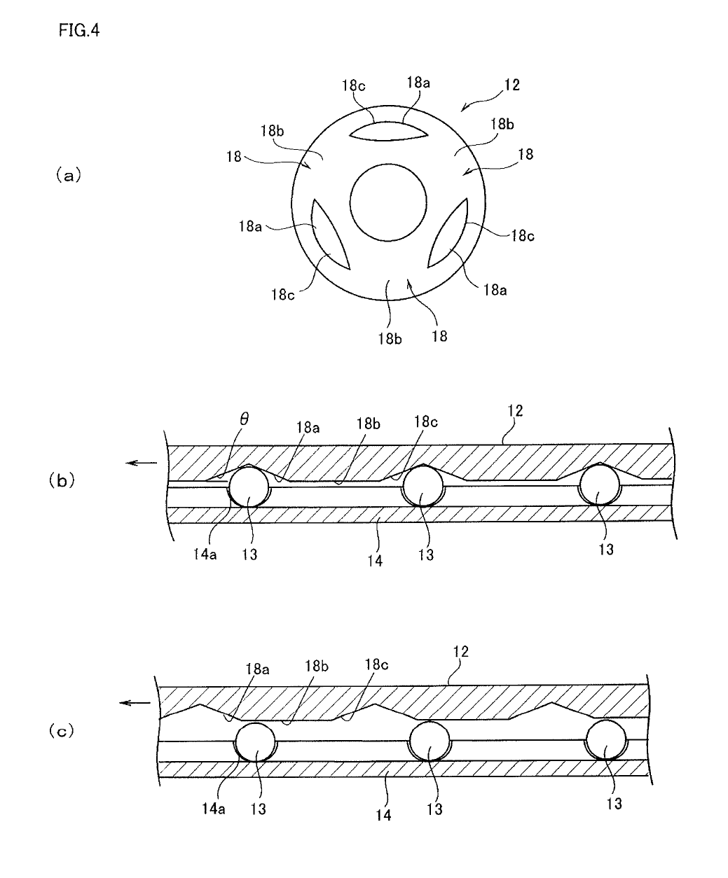

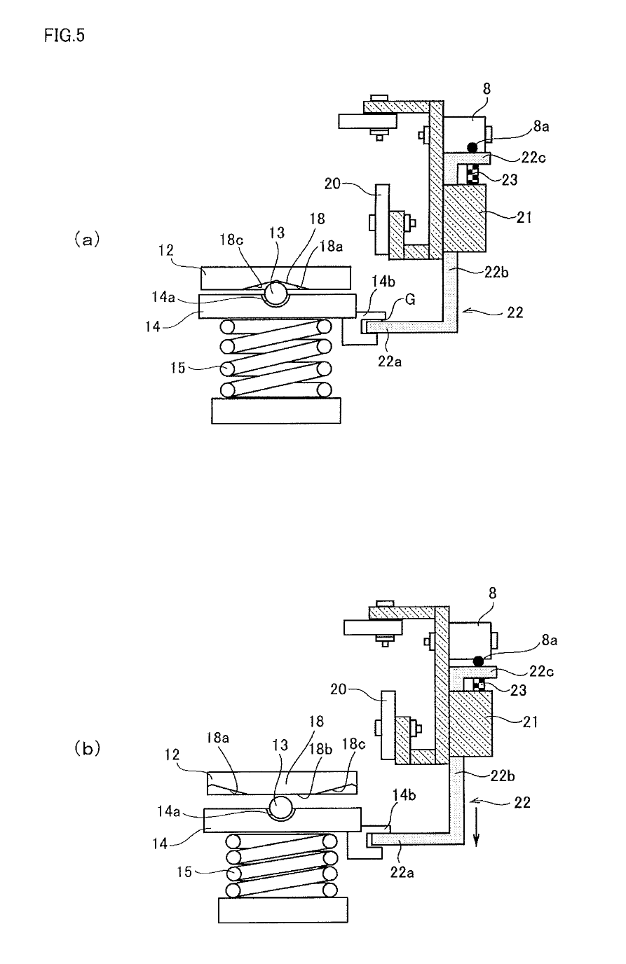

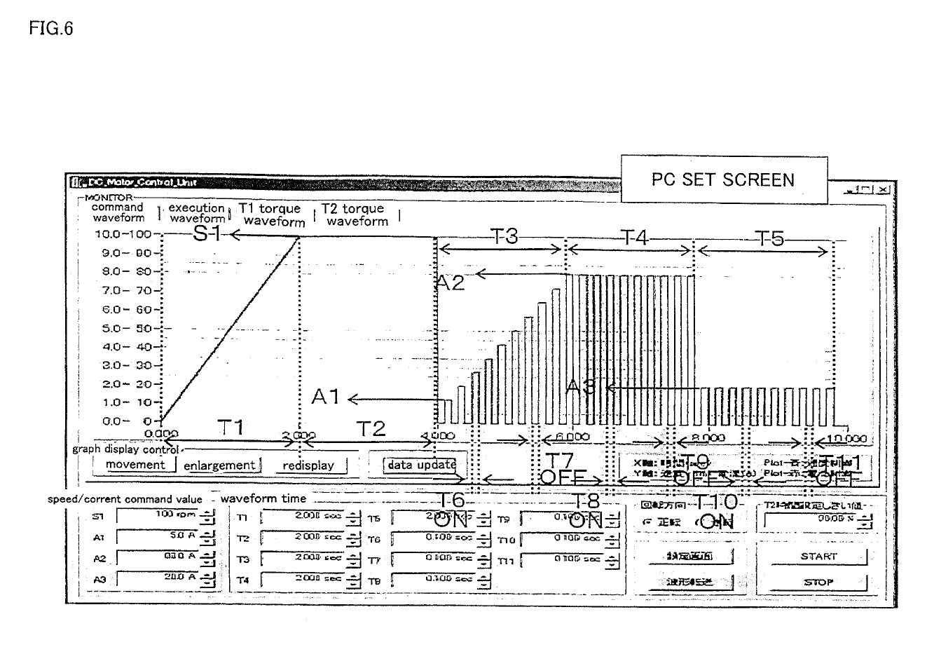

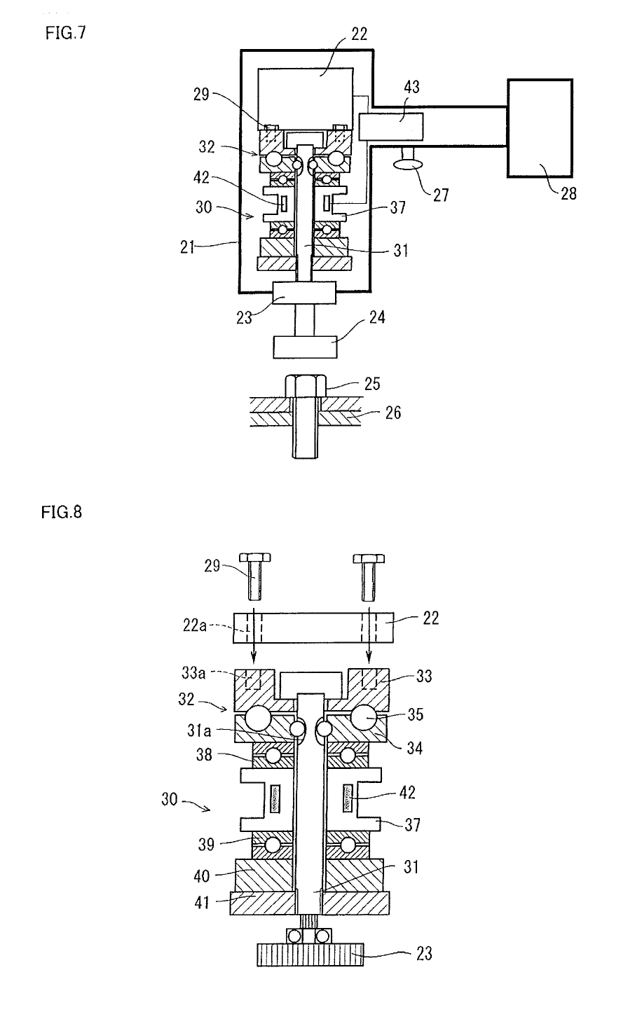

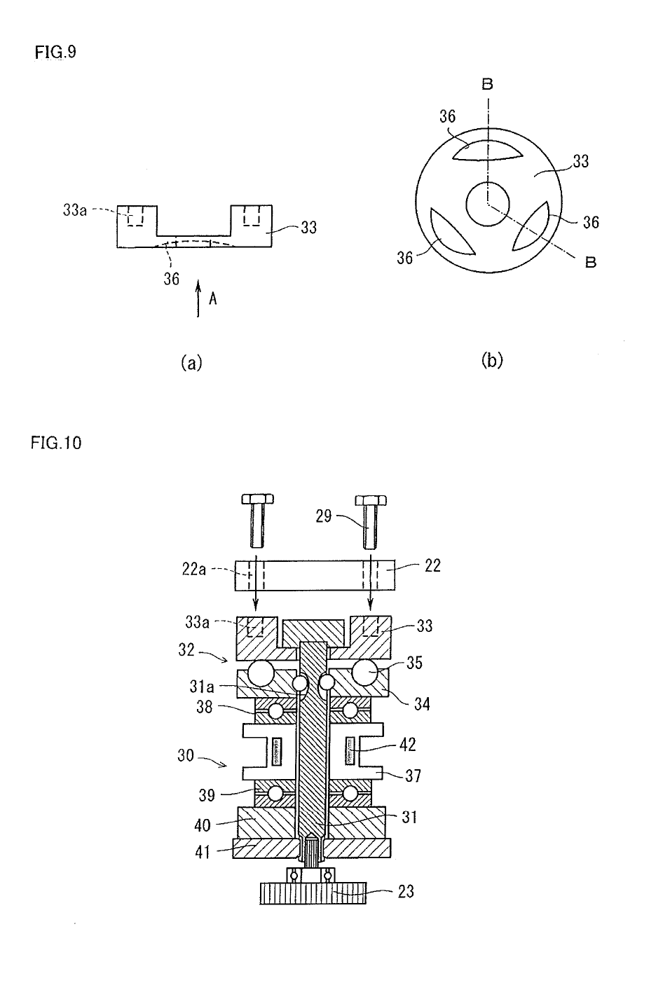

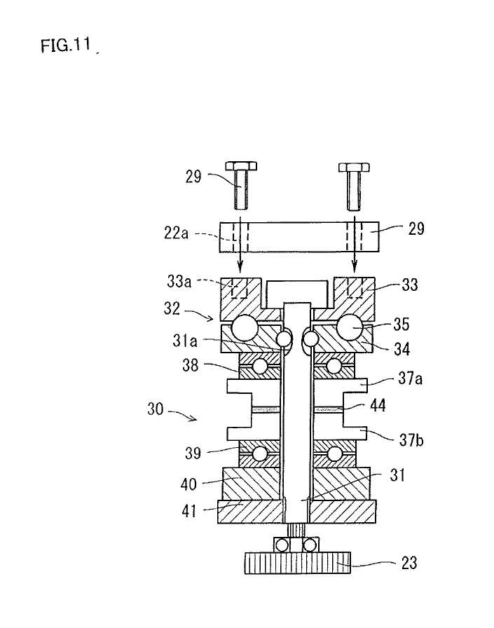

### BRIEF DESCRIPTION OF DRAWINGS

[FIG. 1] FIG. 1 is a schematic side view of a screw fastening device according to the present invention.

[FIG. 2] FIG. 2 is a schematic top view of the screw fastening device according to the present invention.

[FIG. 3] FIG. 3 is an explanatory view of a clutch, FIG. 3(a) is a sectional view, and FIG. 3(b) is an exploded view.

[FIG. 4] FIG. 4 is an explanatory view of a retainer plate, FIG. 4(a) is a plane view of the retainer plate, FIG. 4(b) is a sectional development showing a relationship of the retainer plate, a steel ball and a retainer (clutch non-operating state), and FIG. 4(c) is a sectional development showing the relationship of the retainer plate, the steel ball and the retainer (clutch operating state).

[FIG. 5] FIG. 5 is an operation explanatory view of a displacement switch, FIG. 5(a) is an on state, and FIG. 5(b) is an off state.

[FIG. 6] FIG. 6 is a view showing an example of a computer set screen of an intermittent control controller.

[FIG. 7] FIG. 7 is a view showing a fastening tool to which the torque sensor according to the present invention is applied.

[FIG. 8] FIG. 8 is a sectional view of the torque sensor according to the present invention, and is a sectional view taken along B-B line of FIG. 3(b).

[FIG. 9] FIG. 9(a) is a side view of the retainer plate, and FIG. 9(b) is an arrow view in direction A of FIG. 9(a).

[FIG. 10] FIG. 10 is a sectional view of the torque sensor in a compressed state.

[FIG. 11] FIG. 11 is a sectional view of a torque sensor of another embodiment.

### DESCRIPTION OF EMBODIMENTS

Hereinafter, embodiments of the present invention will be described based on the accompanying drawings. Here, FIG. 1 is a schematic side view of a screw fastening device according to the first invention, FIG. 2 is a schematic top view of the same, FIG. 3 is an explanatory view of a clutch, FIG. 4 is an explanatory view of a retainer plate, and FIG. 5 is an operation explanatory view of a displacement switch.

As shown in FIGS. 1 and 2, the screw fastening device according to the present invention is constituted of a pistol type device main body 1, a controller (not illustrated) which controls a direct-current (DC) motor 3 which constitutes the device main body 1, a lithium ion battery (not illustrated) as a power supply, and a cable 2 which connects the device main body 1 and the controller. The controller and the battery may be attached to a belt wound on the waist of an operator, or may be incorporated into the device main body 1.

The device main body 1 includes the DC motor 3 to be a drive source, a mechanical clutch 5 which transmits the torque of the DC motor 3 to a speed reducer 4, the aforesaid speed reducer 4 constituted of a planetary gear which reduces the rotational frequency of the clutch 5 and the like, a tool socket 6 which fastens an engaged screw by the torque outputted by the speed reducer 4, a grip section (grip part) 7 for an operator to grip with one hand, a lever 7a which is provided at the grip section 7 and the like. The DC motor 3 may be with or without a brush. Further, as shown in FIG. 5, in the clutch 5, a displacement switch 8, which senses the operation state of the clutch 5, is installed.

The DC motor 3 is intermittently supplied with electric power (current) in a pulse form by a controller, and intermittent control for intermittently rotating is performed. By such intermittent control, an impact effect is generated by using backlash of a gear part, a joint part and the like of the speed reducer 4, and torque can be increased. Further, if the cycle of the intermittent time (on/off time) is made short (for example, 0.1 msec), and rotation and stop are repeatedly performed before the fastening reaction force is transmitted to the arm of an operator, the reaction force can be reduced.

As shown in FIG. 3, the clutch 5 is constituted of a clutch rod 11 to which an output shaft of the DC motor 3 is connected, a substantially disk-shaped retainer plate 12, three spherical steel balls 13, a substantially disk-shaped retainer 14, a coil-shaped spring 15, a spring holder 16, an adjust nut 17 and the like. As shown in FIG. 4(a), on one surface of the retainer plate 12, cams 18 (inclined portions 18a, flat portions 18b and inclined portions 18c) are formed by three equal parts in the circumferential direction in the vicinity of an edge portion. Inclination angles θ of the inclined portions 18a and 18c are desirably 10° to 30°.

Further, on one surface of the retainer 14, recessed portions 14a are formed, which house the steel balls 13 each with about a half of the steel ball 13 in a projected state are formed in positions opposed to the cams 18 formed on the retainer plate 12. The steel balls 13 are held between the cams 18 formed on the retainer plate 12 and the grooves 14a formed on the retainer 14.

As shown in FIG. 4(b), the steel ball 13 is located between the inclined portion 18a and the inclined portion 18c before the fastening torque exceeds the elastic force of the spring 15, and when the fastening torque exceeds the elastic force of the spring 15, the steel ball 13 rides on the flat portion 18b of the cam 18 as shown in FIG. 4(c). Even when the DC motor 3 is driven, the steel ball 13 repeatedly rides over the flat portion 18b of the cam 18, whereby transfer of the rotation of the retainer plate 12 by the DC motor 3 to the speed reducer 4 is interrupted, and the rotation of the tool socket 6 is stopped.

The displacement switch 8 is an on/off switch which senses the movement of the retainer 14 which changes in accordance with the position of the steel balls 13 as shown in FIG. 5. The displacement switch 8 is attached to a base member 21 which is fixed to a frame body 20 of the clutch 5. The movement of the retainer 14 is transmitted to the displacement switch 8 by a switch lever 22 which has one end 22a held by an edge portion 14b of the retainer 14 as well as a central portion 22b slidably inserted into a base member 21, and the other end 22c abutting on the displacement switch 8, and a spring damper 23 which is contractedly fitted between the other end 22c of the switch lever 22 and the base member 21. Reference numeral 8a designates a push button which is projected when the displacement switch 8 is in an off state.

As shown in FIG. 5(a), when the steel ball 13 is located between the inclined portion 18a and the inclined portion 18c of the cam 18 which is formed on the retainer plate 12, a predetermined gap G is provided between the retainer 14 and the one end 22a of the switch lever 22. Further, the other end 22c of the switch lever 22 presses the displacement switch 8 by the spring damper 23 to bring the displacement switch 8 in an on state reliably. When the displacement switch 8 is in an on state, the DC motor 3 can be driven. Since the predetermined gap G is provided between the retainer 14 and the one end 22a of the switch lever 22, unneeded movement of the retainer 14 is not transmitted to the switch lever 22.

Meanwhile, as shown in FIG. 5(b), when the steel ball 13 rides on the flat portion 18b of the cam 18 formed on the retainer plate 12, the retainer 14 moves in the direction to compress the spring 15. Thereupon, the retainer 14 presses the one end 22a of the switch lever 22, whereby the switch lever 22 slides with respect to the base member 21, and further, the other end 22c of the switch lever 22 compresses the spring damper 23 to bring the displacement switch 8 into an off state. When the displacement switch 8 is in an off state, the DC motor 3 stops driving.

An operation of the screw fastening device according to the present invention which is constructed as above will be described. First, an operator grips the grip section 7 of the device main body 1 with one hand, and fits a screw to the tool socket 6. Next, the operator positions the tip end of the screw fitted to the tool socket 6 in a screw hole to be a fastened object, and presses a switch (not illustrated) provided at the grip section 7 with a finger. Thereupon, the DC motor 3 starts driving, and the torque generated by the DC motor 3 and the rotational frequency are transmitted to the screw fitted to the tool socket 6 via the clutch 5 and the speed reducer 4.

Since the DC motor 3 is subjected to intermittent control by the controller at this time, the impact effect is generated by using backlash of the gear portion, the joint portion and the like of the speed reducer 4, and the torque can be increased. Further, by setting an intermittent time (on/off time) of, for example, 0.1 msec or the like. rotation and stop are repeated before the fastening reaction force is transmitted to the arm of the operator, and the reaction force can be reduced.

When the screw is threadedly engaged in the screw hole by rotation of the tool socket 6, and the torque reaches desired fastening torque, the steel ball 13 located between the inclined portion 18a and the inclined portion 18c of the cam 18 as shown in FIG. 5(a) rides on the flat portion 18b of the cam 18 as shown in FIG. 5(b), and the retainer 14 moves in the direction to compress the spring 15. At this time, the inclined portions 18a and 18c are each provided with the inclination angle θ of, for example, about 10° as shown in FIGS. 4(b) and (c), and therefore, the steel ball 13 can ride on the flat portion 18b even with low torque.

When the steel ball 13 rides on the flat portion 18b, the clutch 5 interrupts the rotation by the DC motor 3 to stop the rotation of the tool socket 6, and the retainer 14 presses the one end 22a of the switch lever 22, whereby the other end 22c of the switch lever 22 compresses the spring damper 23 to bring the displacement switch 8 into an off state. At this time, the flat portion 18b of the cam 18 on which the steel ball 13 rolls has a predetermined length, and therefore, a pressing time for reliably bringing the displacement switch 8 into an off state can be provided.

When the displacement switch 8 is in an off state, the DC motor 3 stops driving. ate screw is threadedly engaged in the screw hole with the desired fastening torque, and the screw fastening operation for one screw is finished.

FIG. 6 is a view showing an example of a computer set screen of the intermittent control controller, in the screen, S1 represents a rotational speed, A1 to A3 represent currents (torque), and T1 to T11 represent waveform times. In this example, window sections for setting the rotational speed S1, the currents (torque) A1 to A3. and the waveform times T1 to T11 are provided at the lower portion of the screen, a button is in the right side of each of the window sections, and the set condition can be increased and decreased by clicking the buttons. The graphs on the upper half part of the screen express the above-described set conditions with time.

When a start button on the screen is clicked, a motor control command is stored in an input controller from the computer, and the motor is rotated while controlled.

According to the screw fastening device according to the present invention, the clutch 5 is directly connected to the output side of the DC motor 3, whereby the output of the DC motor 3 can be suppressed to be lower than the conventional screw fastening device, and therefore, the DC motor 3 and the clutch 5 can be made compact. Accordingly, the device main body 1 becomes more compact and lighter than the conventional ones. When the size and the weight of the device main body 1 when the fastening torque of, for example, 30 N·m is needed are compared with the conventional one, the result is as follows.

Length (L)×width (W)×height (H) shown in FIGS. 1 and 2 becomes 260 mm×50 mm×150 mm from 500 mm×70 mm×104 mm of the conventional one, and the size of the device main body 1 is reduced by about 50% from that of the conventional one. Further, the weight of the device main body 1 becomes 1.5 kg from 2.4 kg of the conventional one, and is decreased by about 40% from the weight of the conventional one. Concerning the size of the clutch 5 in this case, the diameter D shown in FIG. 3(a) becomes 33 mm from 116 mm of the conventional one, and is decreased by about 80% from that of the conventional one, and the weight of the clutch 5 becomes 200 g from 1200 g of the conventional one, and is decreased by about 70% from that of the conventional one.

In the embodiment of the present invention, it is determined based on the operation state of the displacement switch 8 provided at the clutch 5 (change to an off state from an on state) that the fastening torque reaches the desired value, but the driving time of the DC motor 3 and the operation state of the displacement switch 8 can be set as the conditions for determination. Further, the operation state of the displacement switch 8 can be determined by only the driving time of the DC motor 3.

Next, a preferred embodiment of a torque sensor according to the second invention will be described with reference to the attached drawings. FIG. 7 is a view showing a fastening tool to which the torque sensor according to the present invention is applied, FIG. 8 is a sectional view of the torque sensor according to the present invention and is a sectional view taken along line B-B of FIG. 9(b), FIG. 9(a) is a side view of a retainer plate, FIG. 9(b) is an arrow view in direction A of FIG. 9(a), and FIG. 10 is a sectional view of the torque sensor in a compressed state.

A motor 22, a torque sensor 30 according to the present invention, and a speed reducer 23 are provided inside a case 21 of the fastening tool, a head portion 24 is attachable to and detachable from the speed reducer 23, and the head portion 24 is fitted on a bolt 25 to fasten a fastened object 26. Further, an operation lever 27 is provided at the grip section of the case 21, and a battery 28 is connected to an end portion of the grip section.

The aforesaid torque sensor 30 includes a rotating shaft 31, and a cam mechanism 32 which transmits a drive force from the motor 22 to the rotating shaft 31 via a bearing is disposed in a groove portion 31a formed on an outside surface of the rotating shaft 31. The cam mechanism 32 is constituted of a retainer plate 33 which is connected to the drive shaft of the aforesaid motor 22, a retainer 34 connected to the rotating shaft 31, and steel balls 35 which connect the aforesaid retainer plate 33 and the retainer 34 in such a manner that the retainer plate 33 and the retainer 34 are contactable with and separable from each other.

In a flange portion of the aforesaid motor 22, through holes 22a through which bolts 29 are inserted are formed, bolt mounting holes 33a in which the bolts 29 are threadedly engaged are formed in the aforesaid retainer plate 33, and the motor 22 and the retainer plate 33 are connected by the bolts 29.

Cam grooves 36 are formed on an undersurface of the aforesaid retainer plate 33 as shown in FIG. 9, the steel balls 35 which are held by the aforesaid retainer 34 are engaged in the cam grooves 36, and the drive force of the motor 22 is transmitted to the rotating shaft 31 in this state.

A gauge base 37 is disposed in the intermediate portion of the aforesaid rotating shaft 31 in a non-contact manner so as not to be rotated. The gauge base 37 is formed into a cylinder shape having flange portions at an upper end and a lower end, and is formed from aluminum, a resin (synthetic rubber) or the like.

The material and the shape of the gauge base 37 are not limited to the illustrated ones, and may be those that change in the axial dimension when the force is applied to the gauge base 37 in the axial direction.

The flange portions are supported between the aforesaid retainer 34 and a holder plate 40 fitted over the lower portion of the rotating shaft 31 respectively via thrust bearings 38 and 39 at the upper end and the lower end of the gauge base 37. As a result, the gauge base 37 is floatingly supported at the outer side of the rotating shaft 31.

The holder plate 40 is prevented from removing by an adjust nut 41, and in the case of replacement of the gauge base 37, the adjust nut 41 and the holder plate 40 are removed for replacement.

At the end portion of the rotating shaft 31 to which the aforesaid adjust nut 41 is threadedly attached, a hole in which the rod of the speed reducer 23 is spline-engaged is formed in the axial direction.

Further, a strain gauge 42 as a detecting element is attached to an outer peripheral portion of the aforesaid gauge base 37. An arbitrary number of the strain gauges 42 can be used, and three or four strain gauges 42 are usually attached. A control section 43 is connected to the strain gauge 42.

In the above, while the head portion 24 is fitted on the bolt 25, and the motor 22 is driven to rotate the rotating shaft 31 to fasten the fastened object 26, when the torque reaches the predetermined fastening torque value, the resistance becomes so large that the steel balls 35 ride over the cam grooves 36, the retainer 34 is pressed downward as shown in FIG. 10, the connection state between the retainer plate 33 and the retainer 34 is released, and the drive amount of the motor 22 stops being transmitted to the rotating shaft 31.

When the retainer 34 is pressed downward, the gauge base 37 is compressed in the axial direction, and the strain gauge 42 senses the compression amount. The aforesaid control section 43 converts the measurement value of the strain gauge 42 into torque, and determines that the torque reaches the predetermined torque value to turn off the aforesaid motor 22.

FIG. 11 is a sectional view of a torque sensor of another embodiment, and in the embodiment, the gauge base 37 is divided into an upper and lower half bodies 37a and 37b, and a piezoelectric element 44 as a detecting element is held between these half bodies 37a and 37b.

In the case of adoption of the structure of FIG. 11, the material of the gauge base 17 itself does not have to have elasticity.

### INDUSTRIAL APPLICABILITY

According to the present invention, since the clutch is provided at the input side of the speed reduction mechanism instead of the output side of the speed reduction mechanism, the clutch can be made compact, and therefore, the screw fastening device, which can be made compact and light, is enhanced in operability and makes a screw fastening operation easy even in a narrow place, can provided.

### REFERENCE SIGNS LIST

1 . . . device main body, 3 . . . DC motor (motor), 4 . . . speed reducer, 5 . . . clutch, 6 . . . tool socket, 7 . . . grip section, 7a . . . lever, 8 . . . displacement switch, 11 . . . clutch rod, 12 . . . retainer plate, 13 . . . steel ball, 14 . . . retainer, 15 . . . spring, 18 . . . cam, 18a, 18c . . . inclined portion, 18b . . . flat portion, 22 . . . switch lever, 21 . . . base member, 23 . . . spring damper, θ . . . inclination angle, 21 . . . case for fastening tool, 22 . . . motor, 22a . . . through hole, 23 . . . speed reducer, 24 . . . head portion, 25 . . . bolt, 26 . . . fastened object, 27 . . . lever, 28 . . . battery, 29 . . . bolt, 30 . . . torque sensor, 31 . . . rotating shaft, 31a . . . vertical groove, 32 . . . cam mechanism, 33 . . . retainer plate, 33a . . . bolt attaching hole, 34 . . . retainer, 35 . . . steel ball, 36 . . . cam groove, 37 . . . gauge base, 37a, 37b . . . gauge base half body, 38, 39 . . . thrust bearing, 40 . . . holder plate, 41 . . . adjust nut, 42 . . . strain gauge, 43 . . . control section, 44 . . . piezoelectric element

1. A screw fastening device with a motor used as a drive source, a clutch connected to an output side of the motor, a speed reducer connected to an output side of the clutch, and a tool socket provided at an output side of the speed reducer,
wherein the clutch has a retainer plate and a retainer opposed to each other with a clutch steel ball therebetween, a recessed portion where the steel ball is held in a state with about a half of the steel ball projected is formed on a surface of the retainer which is opposed to the retainer plate, and a cam which comprises a flat portion on which the steel ball rides and an inclined portion in which the steel ball is fitted is formed on one surface of the retainer plate which is opposed to the recessed portion, and
the clutch includes a displacement switch which senses that fastening torque has reached a desired value, the displacement switch is turned on and off by a switch lever connected to the retainer, the switch lever is urged to an on side of the displacement switch by a spring damper, and a gap, which prevents propagation of unnecessary movement of the retainer in a state in which the steel ball is fitted in the inclined portion, is further formed in a connection portion of the retainer and the switch lever.

2. The screw fastening device according to claim 1, wherein the retainer plate includes a retainer rod which is connected to a drive shaft of the motor, and transmits power to the speed reducer via the retainer plate, the retainer and the steel ball, and includes the retainer which is urged by a spring disposed on an outer periphery of the retainer rod.

3. The screw fastening device according to claim 1, wherein an angle of the inclined portion is 10° to 30°.

4. The screw fastening device according to any one of claim 1, wherein electric power in a pulse form is intermittently supplied to the motor with a cycle of 0.1 msec, and the motor is intermittently rotated.

5. A torque sensor that is used in a fastening tool which includes a motor and a speed reducer, has a head portion made attachable to and detachable from the speed reducer, and fastens the head portion onto a bolt to fasten a fastened object, and measures torque which is applied to a rotating shaft, the torque sensor comprising:
a cam mechanism which comprises a retainer plate which is connected to a drive shaft of the motor, a retainer which is connected to the rotating shaft, and a steel ball which connects the retainer plate and the retainer in such a manner that they are contactable with and separable from each other, and transmits a drive force from the motor to the rotating shaft;
a gauge base which is floatingly supported at an outer side of the rotating shaft via a thrust bearing, around the rotating shaft, disposed without contacting the rotating shaft so as not to be rotated, and is capable of being compressed in an axial direction;
a compression amount detecting element which is attached to the gauge base; and
a control section which is connected to the detecting element, converts a measurement voltage corresponding to a compression amount into torque, determines whether or not the torque was reached a predetermined torque by the retainer of the cam being pressed downward and compressing the gauge base in the axial direction when the torque reaches the predetermined fastening torque, and controls the motor upon determining that the torque has reached the predetermined torque.

6. The torque sensor according to claim 5, wherein the gauge base is formed into a cylindrical body made from a metal such as aluminum or an elastic body.

7. The torque sensor according to claim 5, wherein the detecting element is a strain gauge attached to an outer side of the gauge base.

8. The torque sensor according to claim 5, wherein the detecting element is a piezoelectric element which is provided in a space between the gauge bases divided into two in the axial direction.

9. (canceled)

10. (canceled)

11. The screw fastening device according to claim 2, wherein an angle of the inclined portion is 10° to 30°.

12. The screw fastening device according to claim 2, wherein electric power in a pulse form is intermittently supplied to the motor with a cycle of 0.1 msec, and the motor is intermittently rotated.

13. The screw fastening device according to claim 3, wherein electric power in a pulse form is intermittently supplied to the motor with a cycle of 0.1 msec, and the motor is intermittently rotated.

14. The screw fastening device according to claim 11, wherein electric power in a pulse form is intermittently supplied to the motor with a cycle of 0.1 msec, and the motor is intermittently rotated.
